(19) United States
(12) Patent Application Publication
(10) Pub. No.: US 2025/0135931 A1
(43) Pub. Date: May 1, 2025

(54) System and Method for Multi-Space Electric Vehicle Charging

(71) Applicant: Streamline Charging LLC, Reading, PA (US)

(72) Inventors: Melanie Kathleen MacKinnon, Sinking Spring, PA (US); Jonathan James Smith, Reading, PA (US); Mark Brian Yazemboski, Wernersville, PA (US); Nathan Peter Vreeland, Denver, PA (US)

(21) Appl. No.: 18/928,871

(22) Filed: Oct. 28, 2024

Related U.S. Application Data
(60) Provisional application No. 63/593,274, filed on Oct. 26, 2023.
(60) Provisional application No. 63/558,723, filed on Feb. 28, 2024.

(51) Int. Cl. B60L 53/35; B60L 53/18

(52) U.S. Cl. CPC B60L 53/35; B60L 53/18

(57) ABSTRACT

Systems and methods are provided for multi-space vehicle charging. An example system may include a cord management system configured to extend across a plurality of parking spaces and configured to move a charging connector of a cord to at least one selected parking space of the plurality of parking spaces associated with at least one vehicle. The cord may extend from a charging device. An example method may include receiving a request to charge a vehicle located in a parking space of a plurality of parking spaces and/or moving a charging connector of a cord extending from a charging device to the parking space of the vehicle.

### CROSS REFERENCE TO RELATED APPLICATIONS

This application claims priority to U.S. Provisional Patent Application No. 63/593,274, filed Oct. 26, 2023 and U.S. Provisional Patent Application No. 63/558,723, filed Feb. 28, 2024, the disclosures of each of which are hereby incorporated by reference in their entireties.

### BACKGROUND

### 1. Technical Field

This disclosure relates generally to vehicle charging and, in non-limiting embodiments or aspects, to systems, methods, and computer program products for multi-space vehicle charging.

### 2. Technical Considerations

Certain electric vehicle (EV) charging systems have been developed with a focus on long-distance charging infrastructure. However, focusing on long-distance charging applications has resulted in a diminished focus on charging station designs for other contexts, such as multi-space vehicle charging. For example, EV charging stations typically include a stationary unit at each vehicle parking space, and the stationary unit can only charge an EV in one designated parking space. A contributing factor for this limitation is that certain electrical codes require that a charging station's cord only extend 25 feet from the charging station.

Moreover, when a user (e.g., driver, owner, and/or the like) moves away from the EV while it is charging at a charging station for an extended period of time (e.g., longer than the time required to fully charge the EV), the charging station and associated parking space may be unavailable for other EVs during that period of time. This limitation results in inefficiency both in terms of the other EVs not being able to charge and in terms of the charging station not being utilized for extended periods of time. Additionally, the user of the EV at the charging station/in the parking space may be inconvenienced to move their vehicle after charging is complete (e.g., to allow other EVs to move into the parking space and use the charging station), for example, even though the user otherwise may not wish to return to their EV or interrupt other activities.

In addition, installing a charging station at each parking space can be difficult, waste time, and waste resources because a trench (e.g., electrical trenching) and cabling (e.g., electrical cables) is required to make electrical power available at every parking space. Such trenching may require demolishing existing concrete, asphalt, or structures; digging the trench; installing cables; backfilling the trench; pouring new concrete or asphalt or (re-)building structures; maintaining the trenching and cabling, and/or the like.

Furthermore, charging stations are difficult to relocate. For example, charging stations can be large and/or heavy. Also, moving charging stations raises new problems, such as extending trenches, cabling, and/or other means of making power available at the new location of the charging station.

### SUMMARY

Accordingly, provided are improved systems, methods, and computer program products for multi-space vehicle charging (e.g., that overcome some or all of the deficiencies identified above).

According to non-limiting embodiments or aspects, provided is a system for multi-space vehicle charging. An example system may include a cord management system configured to extend across a plurality of parking spaces and configured to move a charging connector of a cord to at least one selected parking space of the plurality of parking spaces associated with at least one vehicle.

In some non-limiting embodiments or aspects, the cord management system may include an input connector configured to connect to a charging device charging connector of a charging device cord of a charging device, and drag chain including at least one cable within the drag chain. The at least one cable may be configured to connect to the input connector. A cart may be connected to the drag chain and movably attached to at least one rail extending across the plurality of parking spaces. The cart may include the cord. The cord may be configured to connect to the at least one cable within the drag chain.

In some non-limiting embodiments or aspects, the cart may include at least one cord feeding assembly configured to at least one of: extend the cord, retract the cord, or any combination thereof.

In some non-limiting embodiments or aspects, the cord management system may be configured to be mounted on a substantially vertical surface.

In some non-limiting embodiments or aspects, the cord management system may include at least one mounting bracket configured to mount the cord management system to the substantially vertical surface.

In some non-limiting embodiments or aspects, the substantially vertical surface may include at least one of: a wall, a support beam, or any combination thereof.

In some non-limiting embodiments or aspects, the cord management system may include at least one support configured to suspend the cord management system above at least one of: a ground, a floor, a substantially horizontal surface, an inclined surface, or any combination thereof.

In some non-limiting embodiments or aspects, the system may further include at least one motor and at least one belt connected to the at least one motor and the cart. The at least one motor may be configured to move the cart along the at least one rail by moving the at least one belt.

In some non-limiting embodiments or aspects, the cart may include at least one sliding element. The at least one rail may include at least one track. The cart may be movably attached to the at least one rail by the at least one sliding element being in contact with the at least one track. The at least one sliding element may be configured to slide along the at least one rail as the cart moves along the at least one rail.

In some non-limiting embodiments or aspects, the system may further include at least one processor configured to receive a request to charge a vehicle of the at least one vehicle and activate the at least one motor to move the charging connector of the cord to a parking space of the plurality of parking spaces associated with the vehicle.

In some non-limiting embodiments or aspects, the system may further include at least one processor configured to receive a request to charge a vehicle of the at least one vehicle and move the charging connector of the cord to a parking space of the plurality of parking spaces associated with the vehicle.

In some non-limiting embodiments or aspects, the cord management system may include at least one cord feeding assembly configured to receive the cord and a cart movably attached to at least one rail and configured to move one or more of the at least one cord feeding assembly to move the cord.

In some non-limiting embodiments or aspects, the cord management system may be configured to be mounted on a vertical surface.

In some non-limiting embodiments or aspects, the at least one vehicle may include at least one of: an electric vehicle, a plug-in hybrid vehicle, or any combination thereof.

In some non-limiting embodiments or aspects, the system may further include a charging device. For example, the cord may from the charging device.

In some non-limiting embodiments or aspects, the charging device may include at least one of: a charging station, a charging pile, or any combination thereof.

In some non-limiting embodiments or aspects, the charging device may include at least one of: a level 1 charger, a level 2 charger, a level 3 charger, or any combination thereof.

In some non-limiting embodiments or aspects, the charging device may include a cord holder.

In some non-limiting embodiments or aspects, the cord management system may be configured to maintain slack of the cord within a target range.

In some non-limiting embodiments or aspects, the charging connector may include at least one charging plug.

In some non-limiting embodiments or aspects, a charging port of each vehicle of the at least one vehicle may include at least one receptacle. The at least one charging plug may be configured to mate with the at least one receptacle.

In some non-limiting embodiments or aspects, the charging connector may be at a distal end of the cord.

In some non-limiting embodiments or aspects, the cord management system may include an overhead structure, which may include a roof, at least two rails under the roof, at least one cord feeding assembly configured to receive the cord, and a cart movably attached to the at least two rails and configured to move one or more of the at least one cord feeding assembly to move the cord.

In some non-limiting embodiments or aspects, the at least one cord feeding assembly may be further configured to at least one of: extend or retract the cord to move the charging connector of the cord to a charging port of the at least one vehicle.

According to non-limiting embodiments or aspects, provided is a method for multi-space vehicle charging. An example method may include receiving a request to charge a vehicle located in a parking space of a plurality of parking spaces and moving a charging connector of a cord to the parking space of the vehicle.

In some non-limiting embodiments or aspects, the cord extends from a charging device.

In some non-limiting embodiments or aspects, whether the charging device is in use may be determined.

In some non-limiting embodiments or aspects, moving the charging connector of the cord may include moving the charging connector of the cord to the parking space of the vehicle based on determining that the charging device is not in use.

In some non-limiting embodiments or aspects, the vehicle may be added to a queue based on determining that the charging device is in use. A notification may be communicated when the charging device is no longer in use based on a position of the vehicle in the queue. Moving the charging connector of the cord may include moving the charging connector of the cord to the parking space of the vehicle based on determining that the charging device is no longer in use and based on the position of the vehicle in the queue.

In some non-limiting embodiments or aspects, moving the charging connector of the cord may include lowering the charging connector of the cord.

In some non-limiting embodiments or aspects, moving the charging connector of the cord may include automatically mating the charging connector of the cord with a charging port of the vehicle.

In some non-limiting embodiments or aspects, the charging connector of the cord may be automatically disconnected from the charging port of the vehicle upon completion of charging.

In some non-limiting embodiments or aspects, a charging completion time may be communicated.

In some non-limiting embodiments or aspects, moving the charging connector of the cord may include horizontally translating the charging connector of the cord.

In some non-limiting embodiments or aspects, a cord management system may include at least one cord feeding assembly configured to receive the cord and a cart movably attached to at least one rail and configured to move one or more of the at least one cord feeding assembly to move the cord. For example, moving the charging connector of the cord may include moving the cart.

In some non-limiting embodiments or aspects, the cord management system may be configured to be mounted on a vertical surface.

In some non-limiting embodiments or aspects, an account for a user associated with the vehicle may be created before receiving the request to charge the vehicle. Vehicle data associated with at least one vehicle including the vehicle may be received before receiving the request to charge the vehicle. Location data may be received before receiving the request to charge the vehicle. A charging session may be scheduled based on receiving the request to charge the vehicle. Moving the charging connector may include moving the charging connector of the cord to the parking space of the vehicle during the charging session.

According to non-limiting embodiments or aspects, provided is at least one non-transitory computer-readable medium for multi-space vehicle charging. For example, at least one non-transitory computer-readable medium may include instructions that, when executed by at least one processor, cause the at least one processor to perform any of the methods described herein.

Further non-limiting embodiments or aspects are set forth in the following numbered clauses:

Clause 1: A system for multi-space vehicle charging, comprising: a cord management system configured to extend across a plurality of parking spaces and configured to move a charging connector of a cord to at least one selected parking space of the plurality of parking spaces associated with at least one vehicle.

Clause 2: The system of clause 1, wherein the cord management system comprises: an input connector configured to connect to a charging device charging connector of a charging device cord of a charging device; a drag chain comprising at least one cable within the drag chain, the at least one cable configured to connect to the input connector; and a cart connected to the drag chain and movably attached to at least one rail extending across the plurality of parking spaces, the cart comprising the cord, the cord configured to connect to the at least one cable within the drag chain.

Clause 3: The system of clause 1 or clause 2, wherein the cart comprises at least one cord feeding assembly configured to at least one of: extend the cord, retract the cord, or any combination thereof.

Clause 4: The system of any of clauses 1-3, wherein the cord management system is configured to be mounted on a substantially vertical surface.

Clause 5: The system of any of clauses 1-4, wherein the cord management system comprises at least one mounting bracket configured to mount the cord management system to the substantially vertical surface.

Clause 6: The system of any of clauses 1-5, wherein the substantially vertical surface comprises at least one of: a wall, a support beam, or any combination thereof.

Clause 7: The system of any of clauses 1-6, wherein the cord management system comprises at least one support configured to suspend the cord management system above at least one of: a ground, a floor, a substantially horizontal surface, an inclined surface, or any combination thereof.

Clause 8: The system of any of clauses 1-7, further comprising: at least one motor; and at least one belt connected to the at least one motor and the cart, wherein the at least one motor is configured to move the cart along the at least one rail by moving the at least one belt.

Clause 9: The system of any of clauses 1-8, wherein the cart comprises at least one sliding element, wherein the at least one rail comprises at least one track, wherein the cart is movably attached to the at least one rail by the at least one sliding element being in contact with the at least one track, and wherein the at least one sliding element is configured to slide along the at least one rail as the cart moves along the at least one rail.

Clause 10: The system of any of clauses 1-9, further comprising at least one processor configured to: receive a request to charge a vehicle of the at least one vehicle; and activate the at least one motor to move the charging connector of the cord to a parking space of the plurality of parking spaces associated with the vehicle.

Clause 11: The system of any of clauses 1-10, further comprising at least one processor configured to: receive a request to charge a vehicle of the at least one vehicle; and move the charging connector of the cord to a parking space of the plurality of parking spaces associated with the vehicle.

Clause 12: The system of any of clauses 1-11, wherein the cord management system comprises: at least one cord feeding assembly configured to receive the cord; and a cart movably attached to at least one rail and configured to move one or more of the at least one cord feeding assembly to move the cord.

Clause 13: The system of any of clauses 1-12, wherein the cord management system is configured to be mounted on a vertical surface.

Clause 14: The system of any of clauses 1-13, wherein the at least one vehicle comprises at least one of: an electric vehicle, a plug-in hybrid vehicle, or any combination thereof.

Clause 15: The system of any of clauses 1-16, further comprising: a charging device, wherein the cord extends from the charging device.

Clause 16: The system of any of clauses 1-15, wherein the charging device comprises at least one of: a charging station, a charging pile, or any combination thereof.

Clause 17: The system of any of clauses 1-16, wherein the charging device comprises at least one of: a level 1 charger, a level 2 charger, a level 3 charger, or any combination thereof.

Clause 18: The system of any of clauses 1-16, wherein the charging device comprises a cord holder.

Clause 19: The system of any of clauses 1-18, wherein the cord management system is configured to maintain slack of the cord within a target range.

Clause 20: The system of any of clauses 1-19, wherein the charging connector comprises at least one charging plug.

Clause 21: The system of any of clauses 1-20, wherein a charging port of each vehicle of the at least one vehicle comprises at least one receptacle, and wherein the at least one charging plug is configured to mate with the at least one receptacle.

Clause 22: The system of any of clauses 1-21, wherein the charging connector is at a distal end of the cord.

Clause 23: The system of any of clauses 1-22, wherein the cord management system comprises an overhead structure comprising: a roof; at least two rails under the roof; at least one cord feeding assembly configured to receive the cord; and a cart movably attached to the at least two rails and configured to move one or more of the at least one cord feeding assembly to move the cord.

Clause 24: The system of any of clauses 1-23, wherein the at least one cord feeding assembly is further configured to at least one of: extend or retract the cord to move the charging connector of the cord to a charging port of the at least one vehicle.

Clause 25: A method for multi-space vehicle charging, comprising: receiving, with at least one processor, a request to charge a vehicle located in a parking space of a plurality of parking spaces; and moving, with at least one processor, a charging connector of a cord to the parking space of the vehicle.

Clause 26: The method of clause 25, wherein the cord extends from a charging device.

Clause 27: The method of clause 25 or clause 26, further comprising determining, with at least one processor, whether the charging device is in use.

Clause 28: The method of any of clauses 25-27, wherein moving the charging connector of the cord comprises moving the charging connector of the cord to the parking space of the vehicle based on determining that the charging device is not in use.

Clause 29: The method of any of clauses 25-28, further comprising: adding, with at least one processor, the vehicle to a queue based on determining that the charging device is in use; and communicating, with at least one processor, a notification when the charging device is no longer in use based on a position of the vehicle in the queue, wherein moving the charging connector of the cord comprises moving the charging connector of the cord to the parking space of the vehicle based on determining that the charging device is no longer in use and based on the position of the vehicle in the queue.

Clause 30: The method of any of clauses 25-29, wherein moving the charging connector of the cord comprises lowering the charging connector of the cord.

Clause 31: The method of any of clauses 25-30, wherein moving the charging connector of the cord comprises automatically mating the charging connector of the cord with a charging port of the vehicle.

Clause 32: The method of any of clauses 25-31, further comprising automatically disconnecting, with at least one processor, the charging connector of the cord from the charging port of the vehicle upon completion of charging.

Clause 33: The method of any of clauses 25-32, further comprising communicating, with at least one processor, a charging completion time.

Clause 34: The method of any of clauses 25-33, wherein moving the charging connector of the cord comprises horizontally translating the charging connector of the cord.

Clause 35: The method of any of clauses 25-34, wherein a cord management system comprises at least one cord feeding assembly configured to receive the cord and a cart movably attached to at least one rail and configured to move one or more of the at least one cord feeding assembly to move the cord, and wherein moving the charging connector of the cord comprises moving the cart.

Clause 36: The method of any of clauses 25-35, wherein the cord management system is configured to be mounted on a vertical surface.

Clause 37: The method of any of clauses 25-36, further comprising: creating, with at least one processor, an account for a user associated with the vehicle before receiving the request to charge the vehicle; receiving, with at least one processor, vehicle data associated with at least one vehicle comprising the vehicle before receiving the request to charge the vehicle; receiving, with at least one processor, location data before receiving the request to charge the vehicle; and scheduling, with at least one processor, a charging session based on receiving the request to charge the vehicle, wherein moving the charging connector comprises moving the charging connector of the cord to the parking space of the vehicle during the charging session.

Clause 38: At least one non-transitory computer-readable medium comprising instructions that, when executed by at least one processor, cause the at least one processor to perform the method of any of clauses 25-37.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIGS. 1A-1C are schematic diagrams of an example system for multi-space vehicle charging, according to some non-limiting embodiments or aspects;

FIGS. 2A-2D are schematic diagrams of an example system for multi-space vehicle charging, according to some non-limiting embodiments or aspects;

FIGS. 3A-3G are schematic diagrams of an example cord management system for multi-space vehicle charging, according to some non-limiting embodiments or aspects;

FIGS. 4A and 4B are schematic diagrams of an example system for multi-space vehicle charging, according to some non-limiting embodiments or aspects;

FIGS. 5A-5D are schematic diagrams of an example system for multi-space vehicle charging, according to some non-limiting embodiments or aspects;

FIG. 6 is a schematic diagram of electrical trenching for vehicle charging, according to some non-limiting embodiments or aspects;

FIGS. 7A-7E are schematic diagrams of an example system for multi-space vehicle charging, according to some non-limiting embodiments or aspects;

FIG. 8A is a flow diagram of an example method for multi-space vehicle charging, according to some non-limiting embodiments or aspects;

FIG. 8B is a flow diagram of an example method for multi-space vehicle charging, according to some non-limiting embodiments or aspects;

FIGS. 9A-9K are screenshots of an example graphical user interface for a user device for use with a system for multi-space vehicle charging, according to some non-limiting embodiments or aspects;

FIG. 10 is a flow diagram of an example method for multi-space vehicle charging, according to some non-limiting embodiments or aspects; and

FIG. 11 is a schematic diagram of example components of one or more devices of a system for multi-space vehicle charging, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “electric vehicle (EV)” may refer to a completely electric vehicle, a plug-in hybrid vehicle, any combination thereof, and/or the like.

As used herein, the term “graphical user interface (GUI)” may refer to a generated display with which a user may interact, either directly or indirectly (e.g., through a keyboard, a mouse, a touchscreen, etc.).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, charging stations, mobile devices, etc.) directly or indirectly communicating in the network environment may constitute a “system.”

As used herein, the term “system” may refer to one or more devices or combinations of devices (e.g., computing devices, such as processors, servers, client devices, software applications, components of such, and/or the like).

As used herein, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and/or the like.

Reference to “a system”, “a device,” “a server,” “a processor,” and/or the like, as used herein, may refer to a previously-recited system, device, server, or processor that is recited as performing a previous step or function, a different device, server, or processor, and/or a combination of devices, servers, and/or processors. For example, as used in the specification and the claims, a first system, a first device, a first server, or a first processor that is recited as performing a first step or a first function may refer to the same or different system, device, server, or processor recited as performing a second step or a second function.

Non-limiting embodiments or aspects of the disclosed subject matter are directed to systems, methods, and computer program products for multi-space vehicle charging. For example, non-limiting embodiments or aspects of the disclosed subject matter provide a cord management system configured to extend across a plurality of parking spaces and configured to move a charging connector of a cord to at least one selected parking space of the plurality of parking spaces associated with at least one vehicle. In this way, a single charging device (e.g., charging station) may be used to charge EVs in multiple (e.g., three or more) designated parking spaces. For example, the cord management system allows for the charging connector to be moved to the charging port of a vehicle more than, for example, 25 feet from the charging station (e.g., 50 feet or more) while being compliant with electrical codes. Moreover, the cord management system enables charging of a different (e.g., second, third, etc.) EV (e.g., in a different parking space) without requiring moving an initial (e.g., first) EV from its parking space. Accordingly, even if the user (e.g., driver, owner, and/or the like) of the initial EV moves away from that EV for an extended period of time (e.g., during and after the time required to fully charge the EV), the charging station remains available for other EVs during that period of time. In this way, efficiency is improved both in terms of the other EVs being able to charge and in terms of the charging station being utilized more often (e.g., for a greater proportion of the day), and the user of the initial EV is not inconvenienced to move the EV after charging is complete (e.g., preventing interruption of other activities). For example, apartment complexes, car dealerships, parking lots, parking garages, office buildings, car dealerships, hotels, vehicle fleet parking areas, and/or the like may benefit from multi-space vehicle charging enabled by the disclosed subject matter. In addition, the multi-space vehicle charging enabled by the disclosed subject matter improves ease of installation and conserves time and resources because less trenching (e.g., electrical trenching) and/or cabling (e.g., electrical cables) is required to make electrical power available at multiple parking spaces. For example, such trenching and/or cabling may be required only to extend to a single charging device (e.g., charging station), and the cord management system may allow for electrical power being available at multiple parking spaces. Furthermore, the disclosed subject matter enables making the charging capabilities (e.g., electrical power delivery) of a single charging device (e.g., charging station) available at multiple parking spaces without requiring relocation of the charging device.

In addition, non-limiting embodiments or aspects of the disclosed subject matter provide receiving a request to charge a vehicle (e.g., EV) located in a parking space of a plurality of parking spaces and moving a charging connector of a cord to the parking space of the vehicle (e.g., at a time scheduled for charging the vehicle). As such, a user of an EV may know when charging will be available for the EV. In this way, efficiency is improved in terms of the user efficiently planning time to charge the vehicle, multiple EVs being able to charge with a single charging device, and the charging station being utilized more often (e.g., for a greater proportion of the day). Moreover, other users of other EVs are not inconvenienced to move their EVs after charging is complete. For example, public parking areas such as apartment complexes, parking lots, parking garages, office buildings, hotels, and/or the like may benefit from such multi-space vehicle charging enabled by the disclosed subject matter.

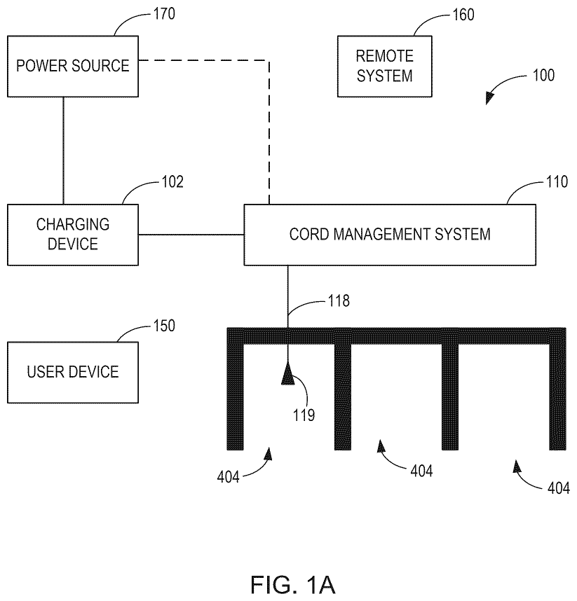

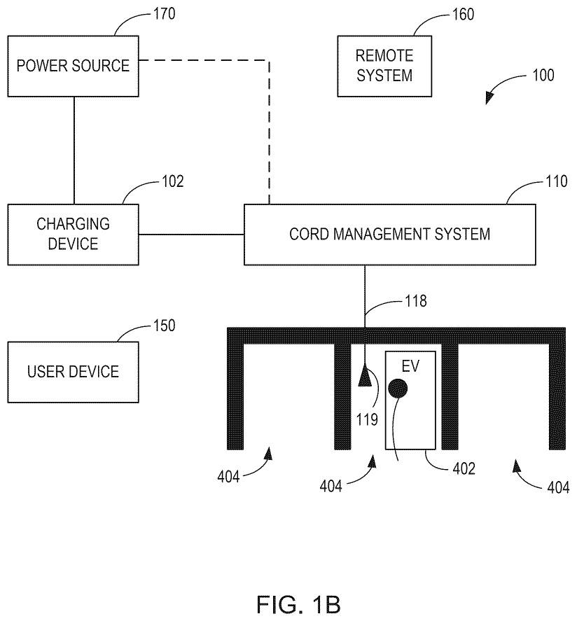

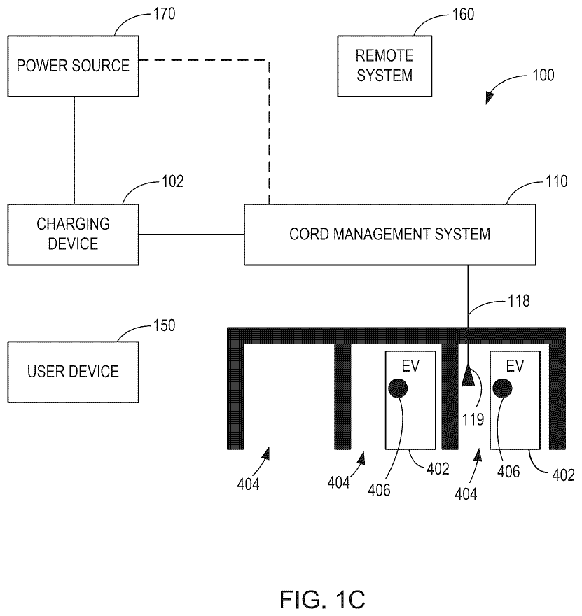

Referring now to FIGS. 1A-1C, shown are schematic diagrams of an example system 100 for multi-space vehicle charging, according to some non-limiting embodiments or aspects. As shown in FIG. 1, system 100 may include at least one of charging device 102, cord management system 110, user device 150, and/or remote system 160.

Charging device 102 may include at least one electronic component, at least one circuit, any combination thereof, and/or the like. Additionally, or alternatively, charging device 102 may include at least one computing device. For example, charging device 102 may include at least one device (e.g., computing device) capable of receiving information from and/or communicating information to cord management system 110, user device 150, and/or remote system 160 (e.g., directly via wired and/or wireless network, via a communication network, and/or any other suitable communication technique). In some non-limiting embodiments or aspects, charging device 102 may include at least one of a charging pile (e.g., EV charging pile), a charging station (e.g., EV charging station, such as a level 1 charger, a level 2 charger, a level 3 charger, any combination thereof, and/or the like), any combination thereof, and/or the like. For example, charging device 102 may receive power from any suitable power source 170, such as a connection to a power grid (e.g., public power grid, municipal power grid, utility power grid, three-phase (e.g., industrial and/or the like) power grid, single phase (e.g., residential and/or the like) power grid, and/or the like), at least one battery (e.g., an array of batteries), at least one solar panel (e.g., an array of solar panels), at least one windmill, a power plant (e.g., coal power plant, natural gas power plant, gasoline power plant, diesel power plant, nuclear power plant, any combination thereof, and/or the like), at least one thermoelectric device, a generator (e.g., diesel generator, gasoline generator, and/or the like), an alternating current (AC) power supply, a direct current (DC) power supply, any combination thereof, and/or the like. In some non-limiting embodiments or aspects, charging device 102 may be configured to convert power. For example, charging device 102 may convert AC power from power source 170 to DC power for charging vehicle 402 (e.g., an EV) (e.g., using an AC-to-DC converter, a rectifier, and/or the like). Additionally, or alternatively, charging device 102 may be configured to convert power from a first potential (e.g., first voltage) to a second potential (e.g., second voltage) (e.g., using a step-up transformer, a step-down transformer, a boost converter, a buck converter, a buck-boost converter, any combination thereof, and/or the like). For example, the second potential may be selected (e.g., predetermined, preselected, dynamically selected, and/or the like) based on the power demands of at least one vehicle 402 to be charged. Additionally, or alternatively, the second potential may be selected to meet and/or exceed a desired charging level of vehicle 402. In some non-limiting embodiments or aspects, charging device 102 (e.g., a computing device thereof) may be configured to control charging of vehicle 402 (e.g., a battery of vehicle 402, which may be an EV).

Cord management system 110 may include at least one electronic component, at least one circuit, any combination thereof, and/or the like. Additionally, or alternatively, cord management system 110 may include at least one computing device. For example, cord management system 110 may include at least one device (e.g., computing device) capable of receiving information from and/or communicating information to charging device 102, user device 150, and/or remote system 160 (e.g., directly via wired and/or wireless network, via a communication network, and/or any other suitable communication technique). In some non-limiting embodiments or aspects, cord management system 110 may be configured to extend across a plurality of parking spaces 404 (e.g., at least three parking spaces, up to eight parking spaces, and/or the like) and/or configured to move charging connector 119 of cord 118 to at least one selected parking space 404 of the plurality of parking spaces 404 associated with at least one vehicle 402, as described herein. For the purpose of illustration, as shown in FIG. 1A, cord 118 and charging connector 119 may initially be located at a first parking space 404. As shown in FIG. 1B, when a first vehicle 402 (e.g., EV) is located at a second parking space 404, cord management system 110 may be configured to move cord 118 and charging connector 119 to the second parking space 404. As shown in FIG. 1C, when a second vehicle 402 (e.g., EV) is located at a third parking space 404, cord management system 110 may be configured to move cord 118 and charging connector 119 to the third parking space 404 (e.g., after the charging session of the first vehicle 402 in the second parking space 404, as described herein).

In some non-limiting embodiments or aspects, charging connector 119 may be at a distal end of cord 118, as described herein.

In some non-limiting embodiments or aspects, cord management system 110 may be electrically connected to charging device 102 and/or power source 170 (which may be the same or a different power source 170 as the power source 170 connected to charging device 102), as described herein. Additionally, or alternatively, cord management system 110 may be configured to supply power (e.g., from charging device 102) through cord 118 to charging connector 119, which may be coupled to charging port 406 of vehicle 402. For example, charging connector 119 may include at least one charging plug (e.g., at least one physical connector for connecting to charging port 406 of vehicle 402, which may contain a battery). For example, charging connector 119 may include a J plug (e.g., SAE J1772 connector), which may be the same as or similar to electrical connectors of Level 1 and/or Level 2 chargers. Additionally, or alternatively, charging connector 119 may include at least one connector that is the same as or similar to the connectors of Level 3 chargers (e.g., a CHAdeMO connector, a CCS connector, a CCS1 connector, a CCS2 connector, a Tesla connector, and/or the like). In some non-limiting embodiments, charging connector 119 may include at least one adapter, e.g., to allow connection between charging connector 119 and charging port 406 of vehicle 402. For example, charging connector 119 may include one (or a small number of) physical connector(s) and a plurality of adapters to allow connection (e.g., electrical connection, coupling, and/or the like) between the physical connector(s) and a plurality of charging ports 406 of vehicles 402 of different types (e.g., different makes, different models, different model years, EVs with J plugs, EVs other charger connectors (e.g., CHAdeMO, CCS, and/or Tesla), any combination thereof, and/or the like). For example, charging port 406 of each vehicle 402 may include at least one receptacle, and charging connector 119 (and/or at least one adapter thereof) may be configured to mate with the receptacle(s).

In some non-limiting embodiments or aspects, cord management system 110 may be configured to at least one of extend or retract cord 118 to move charging connector 119 to charging port 406 of vehicle 402, as described herein.

In some non-limiting embodiments or aspects, cord management system 110 may be configured to maintain slack of the cord within a target range, as described herein.

User device 150 may include at least one computing device. For example, user device 150 may include a mobile device (e.g., a cellular phone, a smartphone, a wearable device (e.g., watches, glasses, lenses, clothing, and/or the like), a PDA, a client device, and/or other like devices), a computer, a portable computer, a laptop computer, a tablet computer, and/or the like. Additionally, or alternatively, user device 150 may include at least one device (e.g., computing device) capable of receiving information from and/or communicating information to charging device 102, cord management system 110, and/or remote system 160 (e.g., directly via wired and/or wireless network, via a communication network, and/or any other suitable communication technique). Although only a single user device 150 is shown, it will be appreciated that a plurality of user devices 150 may be included (e.g., a user device 150 for each user (e.g., driver, owner, and/or the like) of each vehicle 402). In some non-limiting embodiments or aspects, user device 150 may be associated with a user (e.g., driver, owner, and/or the like) of a vehicle 402. In some non-limiting embodiments or aspects, user device 150 may include a device capable of receiving information from and/or communicating information to other user devices 150 (e.g., directly, indirectly, via a public and/or private communication network connection, a short-range communication connection, and/or the like). In some non-limiting embodiments or aspects, user device 150 may include a device capable of receiving information from and/or communicating information to charging device 102 and/or cord management system 110 via a short-range communication connection (e.g., an NFC communication connection, an RFID communication connection, a Bluetooth® communication connection, a Zigbee® communication connection, and/or the like). In some non-limiting embodiments or aspects, user device 150 may be included in (e.g., part of) vehicle 402. In some non-limiting embodiments or aspects, user device 150 may be included in (e.g., part of) charging device 102 (e.g., a user interface thereof, such as a human machine interface (HMI) and/or the like). In some non-limiting embodiments or aspects, user device 150 may be included in (e.g., part of) cord management system 110 (e.g., a user interface thereof, such as a human machine interface (HMI) and/or the like).

Remote system 160 may include at least one computing device. For example, remote system 160 may include a server, a group of servers, and/or other like devices. Additionally, or alternatively, remote system 160 may include at least one device (e.g., computing device) capable of receiving information from and/or communicating information to charging device 102, cord management system 110, and/or user device 150 (e.g., directly via wired and/or wireless network, via a communication network, and/or any other suitable communication technique). For example, remote system 160 may receive a request to charge vehicle 402 from user device 150, as described herein. Additionally, or alternatively, remote system 160 may communicate with charging device 102 and/or cord management system 110 to cause cord management system 110 to move charging connector 119 of cord 118 to parking space 404 of vehicle 402, as described herein. Additionally, or alternatively, remote system 160 may communicate with charging device 102 and/or cord management system 110 to charge vehicle 402, as described herein.

The systems and/or devices of FIGS. 1A-1C may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and devices shown in FIGS. 1A-1C are provided as an example. There may be additional systems and/or devices, fewer systems and/or devices, different systems and/or devices, and/or differently arranged systems and/or devices than those shown in FIGS. 1A-1C. Furthermore, two or more systems or devices shown in FIGS. 1A-1C may be implemented within a single system or device, or a single system or device shown in FIGS. 1A-1C may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

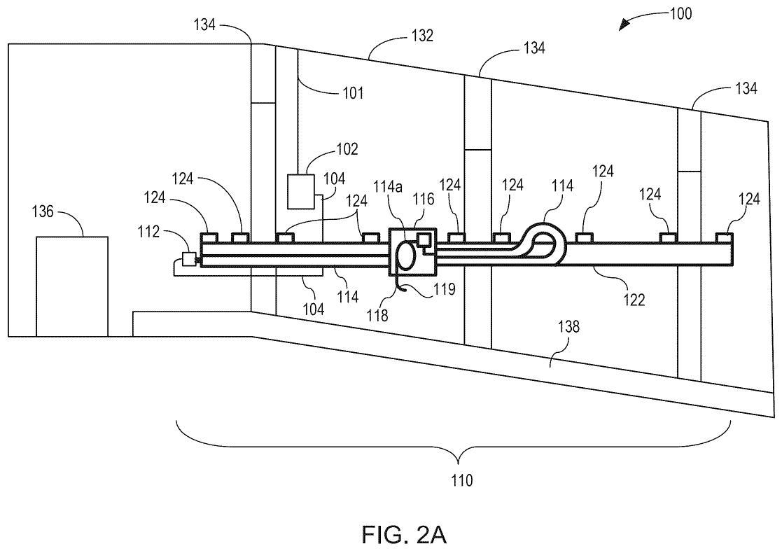

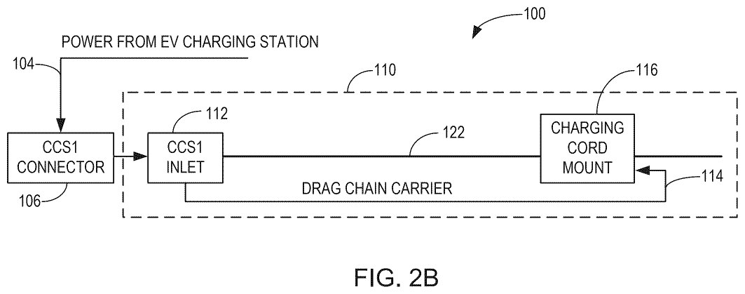

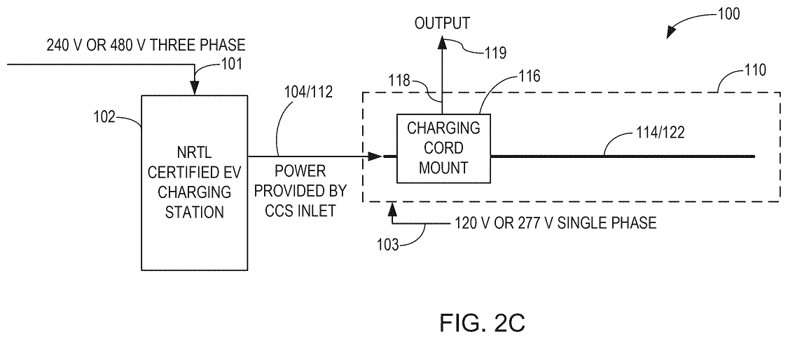

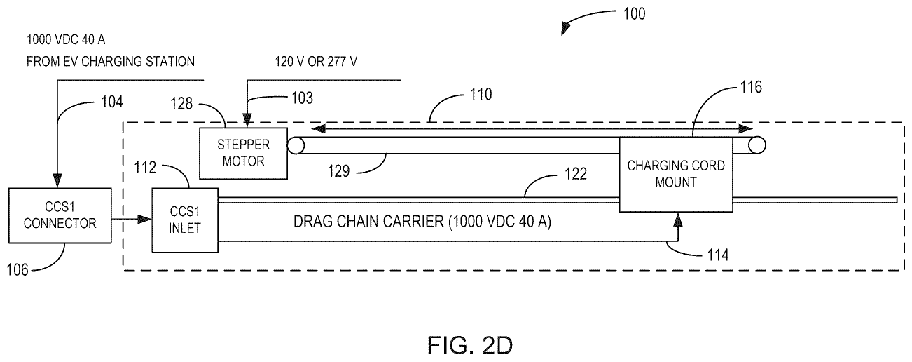

Referring now to FIGS. 2A-2D, shown are schematic diagrams of an example system 100 for multi-space vehicle charging, according to some non-limiting embodiments or aspects.

For the purpose of illustration, in some non-limiting embodiments or aspects, charging device 102 may receive power from a power source (e.g., power source 170) via input power line 101, as described herein. For example, the power source may be a power grid, which may supply suitable power (e.g., 240 V or 480 V three phase (AC) power, 240 V or 277 V single phase (AC) power, 120 V single phase (AC) power, and/or the like) to input power line 101. In some non-limiting embodiments or aspects, cord management system 110 (e.g., motor 128 and/or at least one computing device of cord management system 110) may receive power from additional input power line 103 from a power source (e.g., power source 170), which may be the same power source or a different power source than input power line 101. For example, additional input power line 103 from a power grid (e.g., 277V single phase (AC) power, 120 V single phase (AC) power, and/or the like). In some non-limiting embodiments or aspects, the power source of additional input power line 103 may supply relatively less power than the power source of input power line 101 (e.g., because the power source of additional input power line 103 is not required to supply power to charge a vehicle 402 and, instead, may be suitable for other applications such as powering motor 128 and/or at least one computing device).

Charging device 102 may supply power via charging cord 104 to connector 112 (e.g., inlet connector) of cord management system 110. For example, connector 112 may include at least one receptacle (e.g., J plugs, CHAdeMO, CCS, CCS1, CCS2, and/or Tesla), which may be configured to connect to charging connector 106 (e.g., J plugs, CHAdeMO, CCS, CCS1, CCS2, and/or Tesla) of charging cord 104 of charging device 102. In some non-limiting embodiments or aspects, the power supplied by charging device 102 to charging cord 104 and connector 112 may be suitable for charging a vehicle (e.g., vehicle 402), such as DC power (e.g., DC power of up to 480 V, up to 1000 V, and/or the like and up to 40 A, up to 100 A, up to 500 A, and/or the like).

In some non-limiting embodiments or aspects, cord management system 110 may include at least one drag chain 114 (e.g., a drag chain cable carrier and/or the like). For example, drag chain 114 may include at least one cable therein (e.g., within a channel defined by drag chain 114). In some non-limiting embodiments or aspects, the cable(s) within drag chain 114 may be configured to connect to connector 112 (e.g., at a first (e.g., proximal) end of drag chain 114). For example, the cable(s) within drag chain 114 may receive power from connector 112.

In some non-limiting embodiments or aspects, cord management system 110 may include cart 116 (e.g., a moveable charging cord mount). For example, cart 116 may be connected to drag chain 114 (and/or the cables thereof), e.g., at a second (e.g., distal) end of drag chain 114. In some non-limiting embodiments or aspects, cart 116 may include cord 118 (e.g., with charging connector 119). For example, cord 118 may be configured to connect to the cable(s) within drag chain 114. For example, cord 118 may receive power from the cable(s) within drag chain 114, and cord 118 may supply power via charging connector 119 to a vehicle (e.g., vehicle 402 in one of the parking spaces 404, as described herein). In some non-limiting embodiments or aspects, cart 116 may include cord holder 114a (e.g., a cord feeding assembly). For example, cord holder 114a may be configured to maintain slack of cord 118 within a target range, as described herein. For example, cord holder 114a may include a biasing element (e.g., spring and/or the like) to maintain slack of cord 118. Additionally, or alternatively, cord holder 114a may be configured to at least one of extend cord 118, retract cord 118, any combination thereof, and/or the like.

In some non-limiting embodiments or aspects, cord management system 110 may include at least one motor 128 (e.g., a stepper motor, an AC motor, a DC motor, and/or the like). For example, motor 128 may move belt 129 (e.g., a timing belt and/or the like), which may be connected to cart 116 to cause cart 116 to move along rail 122.

In some non-limiting embodiments or aspects, cord management system 110 may include at least one rail 122 extending across a plurality of parking spaces, as described herein. For example, cart 116 may be configured to move along rail 122, as described herein. In some non-limiting embodiments or aspects, drag chain 114 may be configured to maintain slack of the cables therein within a target range as cart 116 moves along rail 122.

In some non-limiting embodiments or aspects, rail 122 may be mounted on a substantially vertical surface (e.g., a vertical surface, a surface that is oriented within a tolerance range of vertical, and/or the like). For example, rail 122 may be mounted via at least one mounting bracket 124 to a substantially vertical surface, such as wall 132, support beams 134, and/or the like. For example, an environment around cord management system 110 may include features such as walls 132, support beams 134, doors 136, curbs 138, and/or the like. In some non-limiting embodiments or aspects, rail 122 may be mounted on at least one support (e.g., support 125, as described herein, which may include a post, a beam, and/or the like), which may be freestanding (e.g., when cord management system 110 is installed outdoors or in an environment without substantially vertical surfaces suitable for mounting cord management system 110 and/or rail 122 thereof). For example, the support(s) (e.g., support(s) 125, as described herein) may suspend cord management system 110 above at least one of the ground, a floor, a substantially horizontal surface, an inclined surface, any combination thereof, and/or the like.

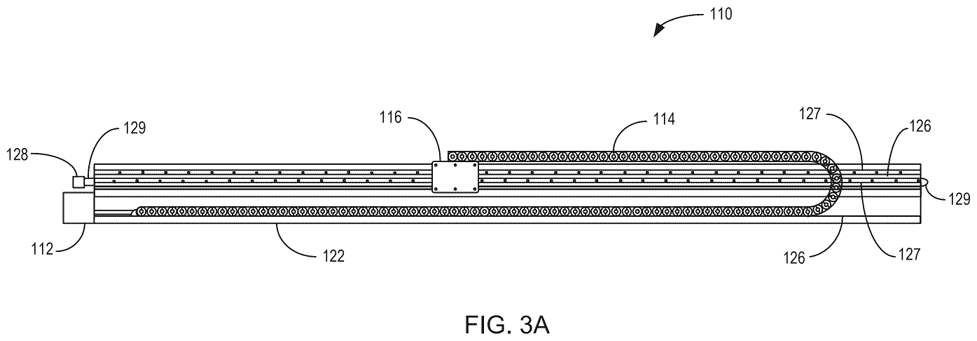

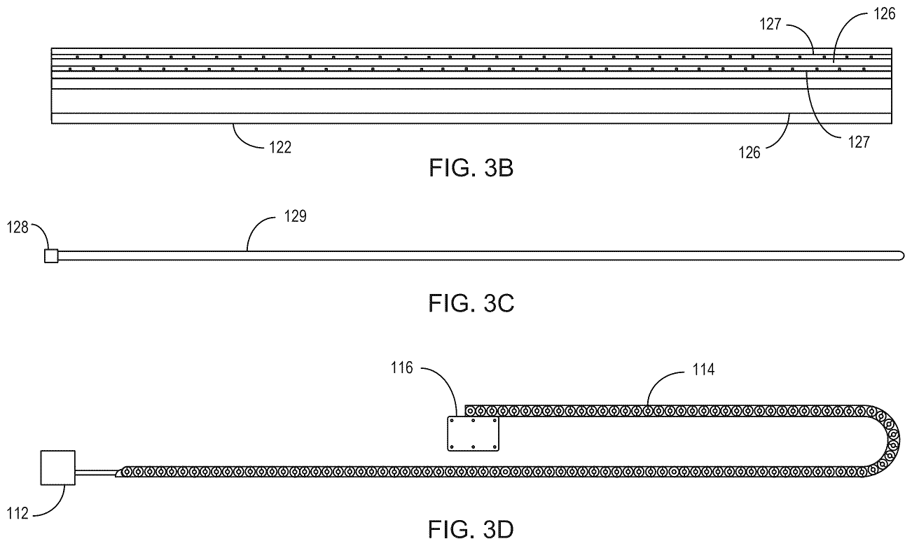

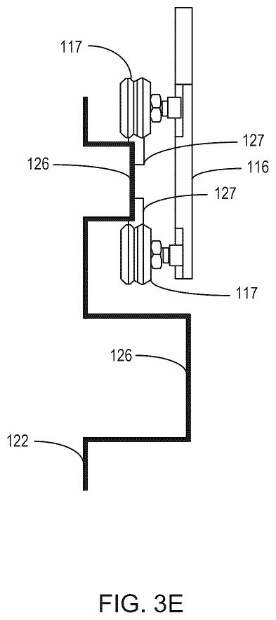

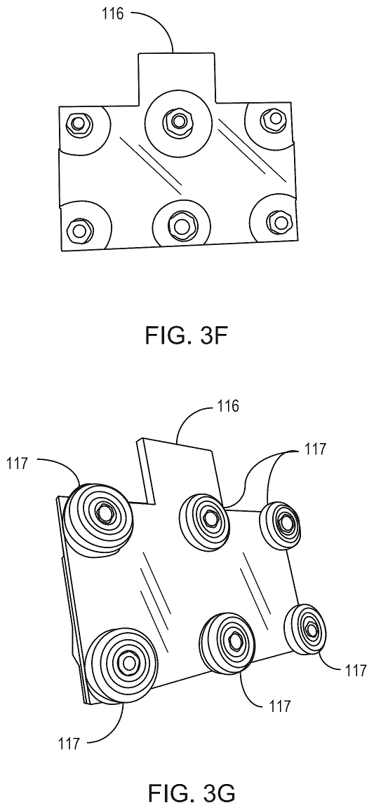

Referring now to FIGS. 3A-3G, shown are schematic diagrams of an example cord management system 110 for multi-space vehicle charging, according to some non-limiting embodiments or aspects. For example, cord management system 110 may include connector 112, drag chain 114, cart 116, rail 122, motor 128, and/or belt 129, as described herein.

In some non-limiting embodiments or aspects, rail 122 may include at least one channel 126 (e.g., a hat channel and/or the like) defined therein. In some non-limiting embodiments or aspects, a first side (e.g., feed side) of belt 129 may be attached to cart 116, and a second side (e.g., return side) of belt 129 may be located within (e.g., behind) a (first) channel 126. As such, motor 128 may move (e.g., translate) cart 116 along rail 122 by moving belt 129.

In some non-limiting embodiments or aspects, cart 116 may include at least one sliding element 117 (e.g., a wheel, a bearing, a linear bearing, and/or the like). For example, cart 116 may include two sliding elements 117, four sliding elements 117, six sliding elements 117, and/or the like. Additionally, or alternatively, rail 122 may include at least one track 127 (e.g., single edge track, dual edge track, and/or the like). For example, rail 122 may include two single edge tracks 127 on a (first) channel 126. In some non-limiting embodiments or aspects, cart 116 may movably attached to rail 122 by sliding element(s) 117 being in contact with track(s) 127, and sliding element(s) 117 may be configured to slide along tracks(s) 127 as cart 116 moves along rail 122.

In some non-limiting embodiments or aspects, drag chain 114 may be connected (e.g., mounted) to a (second) channel 126. Additionally, or alternatively, connector 112 may be connected (e.g., mounted) to the (second) channel 126.

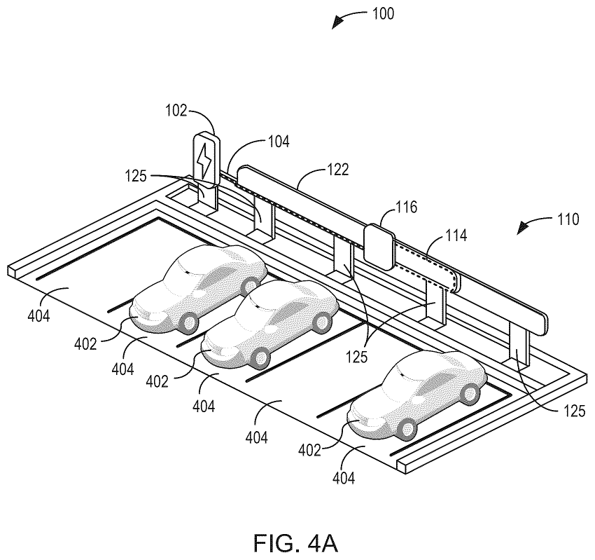

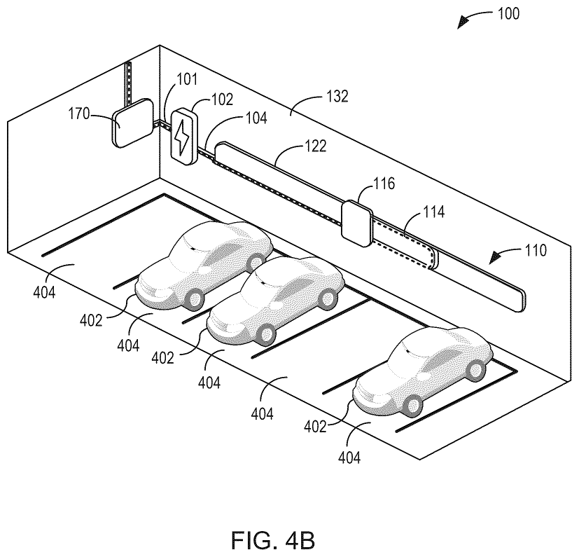

Referring now to FIGS. 4A and 4B, shown are schematic diagrams of an example system 100 for multi-space vehicle charging, according to some non-limiting embodiments or aspects.

For the purpose of illustration, as shown in FIG. 4A, system 100 and/or cord management system 110 may be installed in an outdoor location. For example, cord management system 110 and/or charging device 102 may be mounted on supports 125, as described herein. In this way, cord management system 110 may extend across a plurality of outdoor parking space 404 for vehicles 402 in an outdoor location. Additionally, input power line 101 to charging device 102 may be buried in a trench (e.g., extending below charging device 102).

For the purpose of illustration, as shown in FIG. 4B, system 100 and/or cord management system 110 may be installed in an indoor location. For example, cord management system 110 and/or charging device 102 may be mounted on a substantially vertical surface, such as wall 132, as described herein. In this way, cord management system 110 may extend across a plurality of indoor parking space 404 for vehicles 402 in an indoor location. Additionally, input power line 101 to charging device 102 may be mounted to and/or run along the substantially vertical surface (e.g., wall 132). In some non-limiting embodiments or aspects, power source 170 may include an electrical panel or subpanel (e.g., circuit breaker panel or subpanel, fuse box, and/or the like).

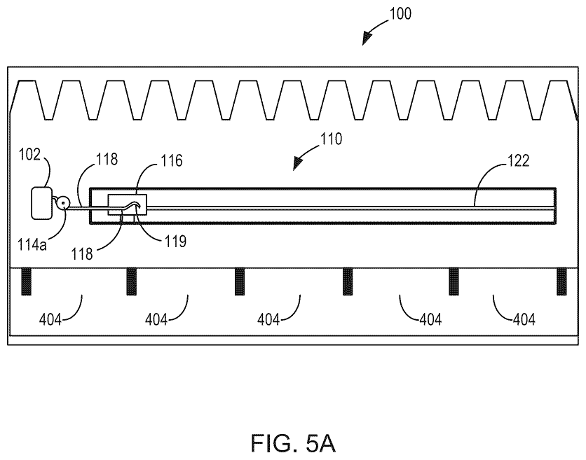

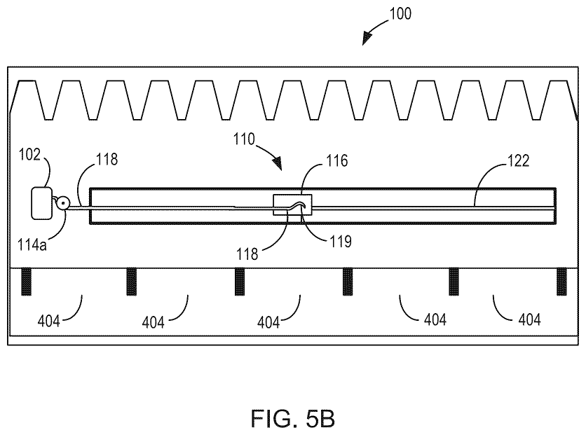

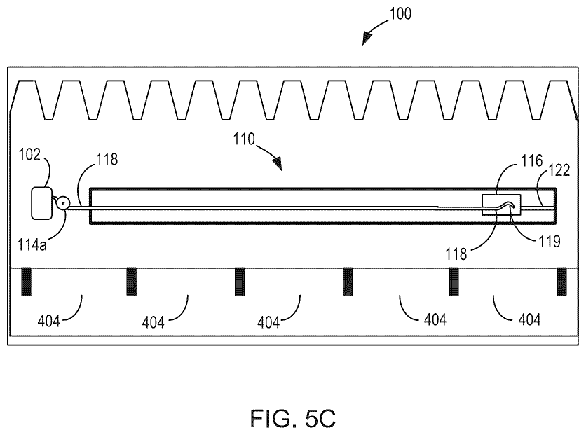

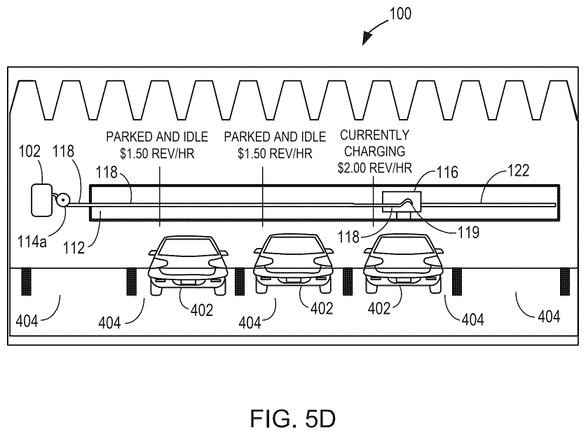

Referring to FIGS. 5A-5D, shown are schematic diagrams of an example system for multi-space vehicle charging, according to some non-limiting embodiments or aspects. As shown in FIGS. 5A-5D, charging device 102 may include cord holder 114a. Additionally, cord 118 may extend from charging device 102. For example, cord holder 114a may be configured to maintain slack of cord 118 within a target range, as described herein.

In some non-limiting embodiments or aspects, cart 116 may be configured to move along rail 122, as described herein. As cart 116 moves along rail 122, cord holder 114a may maintain slack of cord 118 within the target range, as described herein. In some non-limiting embodiments or aspects, cart 116 may include at least one cord feeding assembly configured to receive cord 118, as described herein. For example, moving cart 116 may result in moving the cord feeding assembly to thereby move cord 118 (and/or charging connector 119 thereof).

As shown in FIG. 5D, a plurality of vehicles (e.g., three vehicles 402) may be located in the plurality of parking spaces 404 (e.g., five parking spaces 404). In some non-limiting embodiments or aspects, cord management system 110 may be configured to move cart 116 to the respective parking space 404 of one of the vehicles 402 (e.g., the rightmost vehicle 402). For example, cord management system 110 may move cart 116 to the respective parking space 404 of the rightmost vehicle 402 during a charging session thereof, as described herein. In some non-limiting embodiments or aspects, other vehicles 402 and/or the users thereof may be charged a fee for being parked and/or idle in the other parking spaces 404 (e.g., to promote efficiency and encourage users to move the vehicles 402 or otherwise keep parking spaces 404 clear when a vehicle 402 is not charging).

In some non-limiting embodiments or aspects, cord management system 110 may be configured to be mounted on a vertical surface, as described herein.

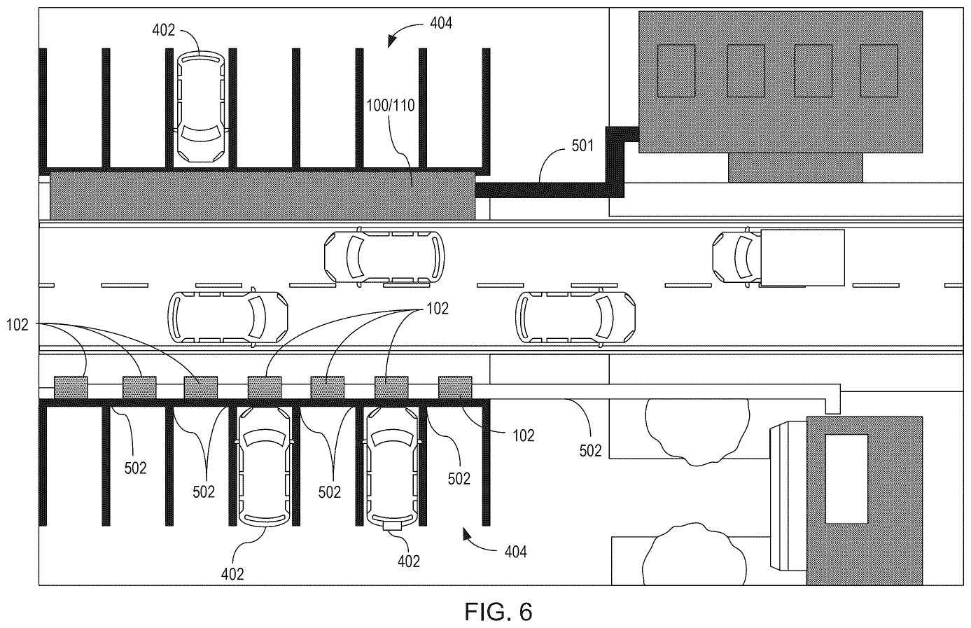

FIG. 6 is a schematic diagram of electrical trenching for vehicle charging, according to some non-limiting embodiments or aspects. For example, as shown inf FIG. 6, first trench 501 may extend to system 100 and/or cord management system 110 thereof, as described herein. Second trench 502 may extend across a plurality of charging devices 102 that do not include cord management system 110.

As shown in FIG. 6, first trench 501 may be significantly shorter than second trench 502. In this way, the multi-space vehicle charging enabled by the disclosed subject matter (e.g., including cord management system 110) improves ease of installation and conserves time and resources because less trenching (e.g., electrical trenching) and/or cabling (e.g., electrical cables) is required to make electrical power available at multiple parking spaces 404 (e.g., for potentially charging multiple vehicles 402).

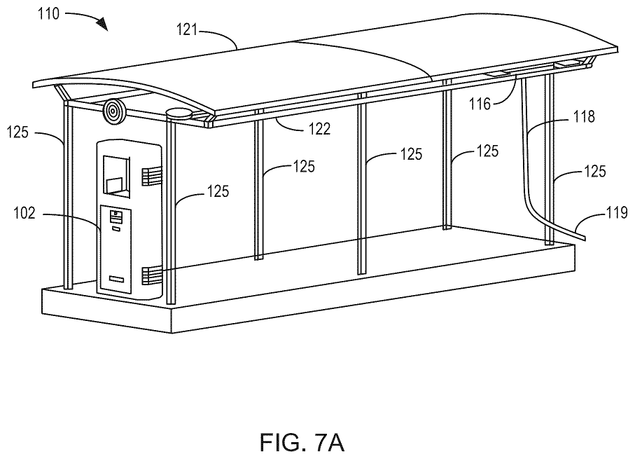

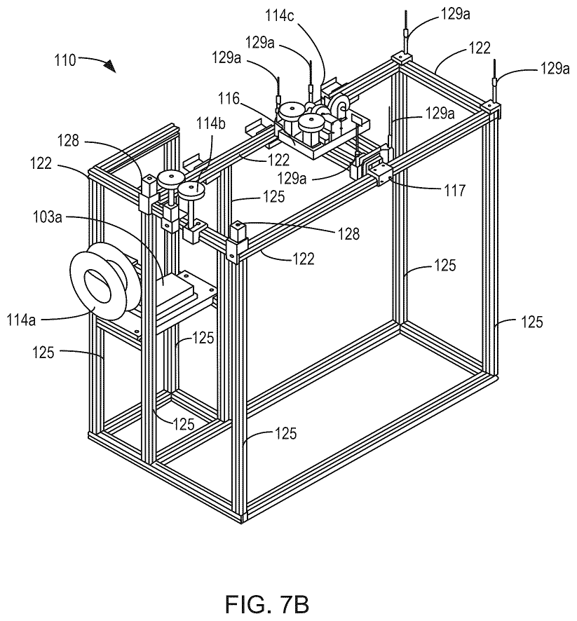

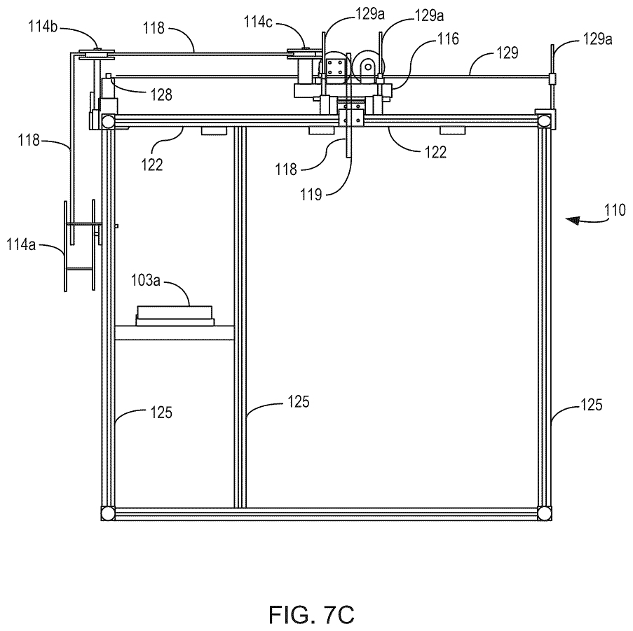

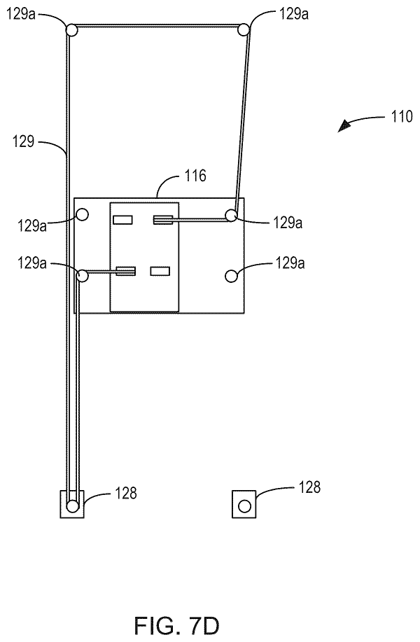

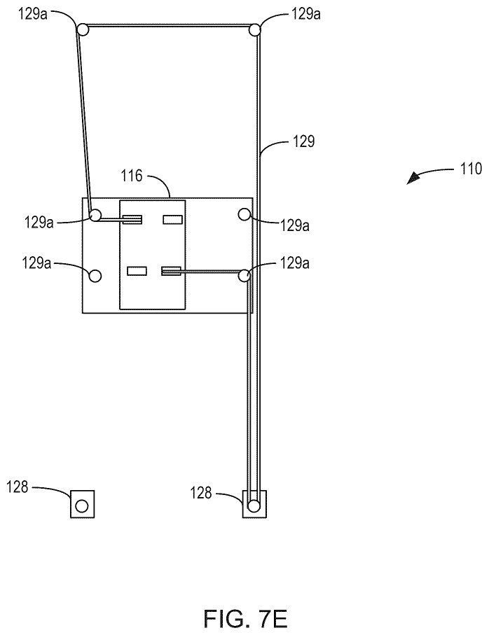

Referring now to FIGS. 7A-7E, shown are schematic diagrams of an example system for multi-space vehicle charging, according to some non-limiting embodiments or aspects. As shown in FIGS. 7A-7E, cord management system 110 may include an overhead structure. For example, the overhead structure may include roof 121, at least two rails 122 under roof 121, and at least one cord feeding assembly (e.g., cord holder 114a, cord feeder 114b, and/or cord feeder 114c) configured to receive cord 118 (e.g., extending from charging device 102). Additionally, or alternatively, the overhead structure and/or components thereof may be suspended by at least one support 125.

In some non-limiting embodiments or aspects, cart 116 may be movably attached to the at least two rails 122 and configured to move one or more of the at least one cord feeding assembly to move cord 118 and/or charging connector 119 thereof. For example, sliding element 117 may include at least one linear bearing configured to slide along at least one of the rails 122 as cart 116 moves along such rails 122.

In some non-limiting embodiments or aspects, at least one of cord holder 114a, cord feeder 114b, and/or cord feeder 114c maintain slack of cord 118 within a target range (e.g., as cart 116 moves), as described herein. In some non-limiting embodiments or aspects, cord holder 114a may be connected to at least one support 125 (and/or to a horizontal member (e.g., rail) extending between at least two supports 125). For example, cord holder 114a and may be configured to remain stationary (e.g., other than rotating to allow cord 118 to extend or retract) when cart 116 moves. Additionally, or alternatively, cord feeder 114b may be connected to at least one rail 122. For example, cord feeder 114b and may be configured to remain stationary (e.g., other than rotating to allow cord 118 to extend or retract) when cart 116 moves. Additionally, or alternatively, cord feeder 114c may be connected to cart 116. For example, cord feeder 114c and may be configured to move with cart 116 (e.g., in addition to being configured to rotate to allow cord 118 to extend or retract) when cart 116 moves along rails 122. In some non-limiting embodiments or aspects, at least one of the cord feeding assemblies (e.g., cord holder 114a, cord feeder 114b, and/or cord feeder 114c) may be configured to allow cord 118 and/or charging connector 119 thereof to extend or retract vertically (e.g., in addition to or in lieu of horizontal movement of cart 116 along rails 122).

In some non-limiting embodiments or aspects, at least one belt 129 (e.g., a timing belt) may be connected to cart 116. Additionally, or alternatively, the belt(s) may be connected to at least one motor 128 (e.g., a stepper motor). For example, at least two stepper motors 128 may be mounted on rails 122 and/or supports 125 of cord management system 110. In some non-limiting embodiments or aspects, the belt(s) 129 may be connected to or in contact with the motor(s) 128 so that motor 128 may cause cart 116 to move by moving belt(s) 129. For the purpose of illustration, as shown in FIGS. 7D and 7E, two belts 129 may be oriented such that a first belt 129 (e.g., belt 129 in FIG. 7D) is above a second belt 129 (e.g., belt 129 in FIG. 7E). Each respective belt 129 may be attached to cart 116 at both ends of the respective belt 129, and the respective belt 129 may be routed around at least one rod 129a (e.g., a plurality of respective rods 129a) so that the respective belt 129 is in contact with a respective motor 128 and slack of belt 129 is maintained within a target range.

In some non-limiting embodiments or aspects, power supply 103a may receive power from a power source 170 (e.g., via additional input power line 103), as described herein. For example, power supply 103a may support power to motor(s) 128 and/or a computing device of cord management system 110.

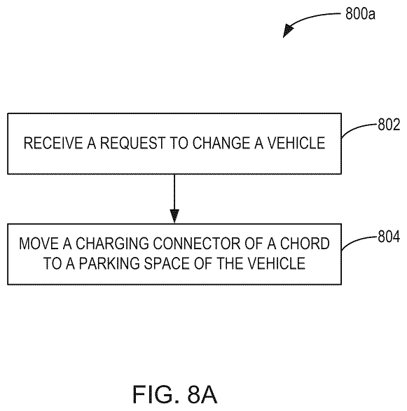

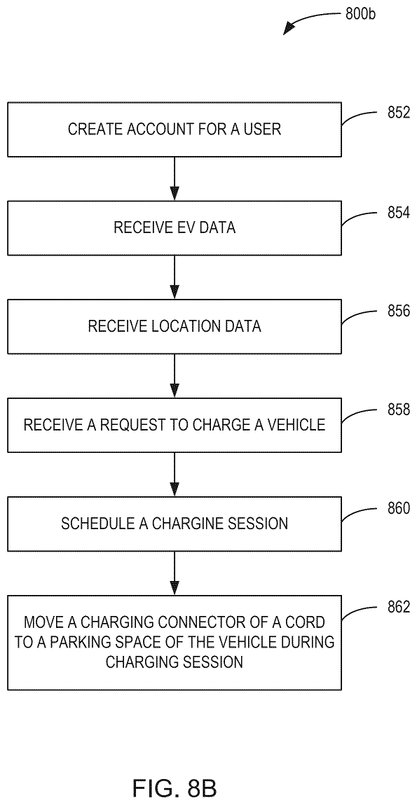

Referring now to FIG. 8A, shown is a flow diagram of an example method 800a for multi-space vehicle charging, according to some non-limiting embodiments or aspects. The steps shown in FIG. 8A are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 800a may be performed (e.g., completely, partially, and/or the like) by cord management system 110 (e.g., a processor or computing device thereof). In some non-limiting embodiments or aspects, one or more of the steps of method 800a may be performed (e.g., completely, partially, and/or the like) by another system, another device, another group of systems, or another group of devices, separate from or including cord management system 110, such as charging device 102 (e.g., a processor or computing device thereof), user device 150, remote system 160, and/or the like.

As shown in FIG. 8A, at step 802, method 800a may include receiving a request to charge a vehicle, as described herein. For example, cord management system 110 and/or charging device 102 may receive a request to charge vehicle 402 (e.g., from user device 150, from an HMI of cord management system 110 and/or charging device 102, and/or from remote system 160). Additionally, or alternatively, remote system 160 may receive a request to charge vehicle 402 from user device 150.

In some non-limiting embodiments or aspects, vehicle 402 may already be in one of the parking spaces 404 associated with cord management system 110 when the request is received. In some non-limiting embodiments or aspects, the request may be a request to schedule a charging session (e.g., a future charging session) for vehicle 402. For example, vehicle 402 may not yet be located in one of the parking spaces 404 associated with cord management system 110. In some non-limiting embodiments or aspects, based on (e.g., in response to) receiving the request, remote system 160, cord management system 110, and/or charging device 102 may communicate a communication to user device 150 based on scheduling a charging session for vehicle 402. For example, the communication may include a time for the charging session, a designated location and/or parking space for the charging session, any combination thereof, and/or the like. Based on the communication, the user of vehicle 402 may navigate vehicle 402 to the designated location/parking space at the designated time.

As shown in FIG. 8A, at step 804, method 800a may include moving a charging connector of a cord to a parking space of the vehicle, as described herein. For example, cord management system 110 may move cart 116 to position cord 118 and/or charging connector 119 at parking space 404 of vehicle 402, as described herein.

In some non-limiting embodiments or aspects, cord management system 110 may move cart 116 based on (e.g., in response to) receiving the request to charge vehicle 402. Additionally, or alternatively, cord management system 110 may move cart 116 in response to a communication (e.g., instruction message) from remote system 160 based on (e.g., in response to) remote system 160 receiving the request to charge vehicle 402.

In some non-limiting embodiments or aspects, cord management system 110 may move cart 116 by activating (e.g., supplying power to, communicating an instruction to, and/or the like) at least one motor 128 to move at least one belt 129 to cause cart 116 to move along rail 122, as described herein. Additionally, or alternatively, moving charging connector 119 of cord 118 may include horizontally translating charging connector 119 of the cord 118 (e.g., via moving cart 116 along rail 122), as described herein.

In some non-limiting embodiments or aspects, cord management system 110 may extend cord 118 and/or charging connector 119 towards vehicle 402, as described herein. Additionally, or alternatively, cord management system 110 may lower charging connector 119 of cord 118, as described herein.

In some non-limiting embodiments or aspects, cord management system 110 and/or remote system 160 may determine whether charging device 102 is in use (e.g., plugged into another vehicle 402, charging another vehicle 402, and/or the like). For example, moving cart 116, cord 118, and/or charging connector 119 may include cord management system 110 performing such movement based on determining that charging device 102 is not in use. Additionally, or alternatively, if charging device 102 is in use, cord management system 110, charging device 102, and/or remote system 160 may add vehicle 402 to a queue based on determining that charging device 102 is in use. In some non-limiting embodiments or aspects, cord management system 110, charging device 102, and/or remote system 160 may communicate a notification (e.g., to user device 150) when charging device 102 is no longer in use based on a position of the vehicle in the queue. Additionally, or alternatively, cord management system 110 may move cart 116, cord 118, and/or charging connector 119 to parking space 404 of vehicle 402 based on determining that charging device 102 is no longer in use and based on the position of vehicle 402 in the queue.

In some non-limiting embodiments or aspects, cord management system 110 may automatically mate (e.g., connect) charging connector 119 of cord 118 with charging port 406 of vehicle 402 (e.g., at the beginning of a charging session, to initiate charging, and/or the like).

In some non-limiting embodiments or aspects, cord management system 110 may automatically disconnect charging connector 119 of cord 118 from charging port 406 of vehicle 402 (e.g., at the end of a charging session, upon completion of charging, and/or the like).

In some non-limiting embodiments or aspects, cord management system 110, charging device 102, and/or remote system 160 may communicate a charging completion time and/or an indication that charging is complete (e.g., to user device 150).

Referring now to FIG. 8B, shown is a flow diagram of an example method 800b for multi-space vehicle charging, according to some non-limiting embodiments or aspects. The steps shown in FIG. 8B are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 800b may be performed (e.g., completely, partially, and/or the like) by cord management system 110 (e.g., a processor or computing device thereof). In some non-limiting embodiments or aspects, one or more of the steps of method 800b may be performed (e.g., completely, partially, and/or the like) by another system, another device, another group of systems, or another group of devices, separate from or including cord management system 110, such as charging device 102 (e.g., a processor or computing device thereof), user device 150, remote system 160, and/or the like.

As shown in FIG. 8B, at step 852, method 800b may include creating an account for a user. For example, user device 150 and/or remote system 160 may create an account for a user associated with vehicle 402.

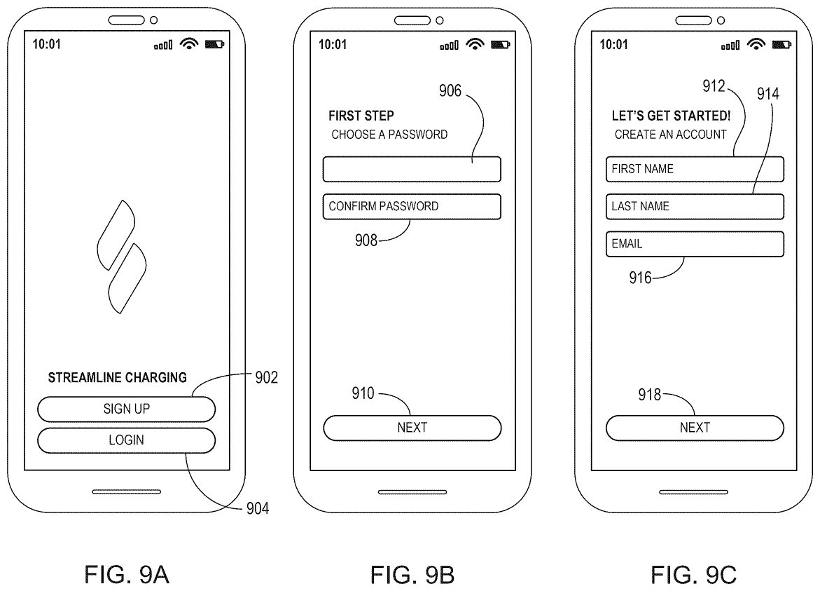

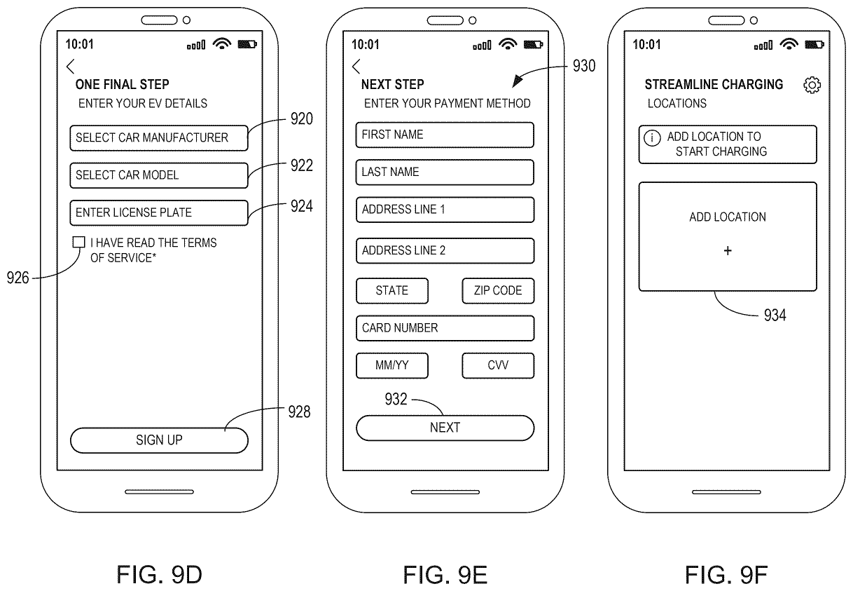

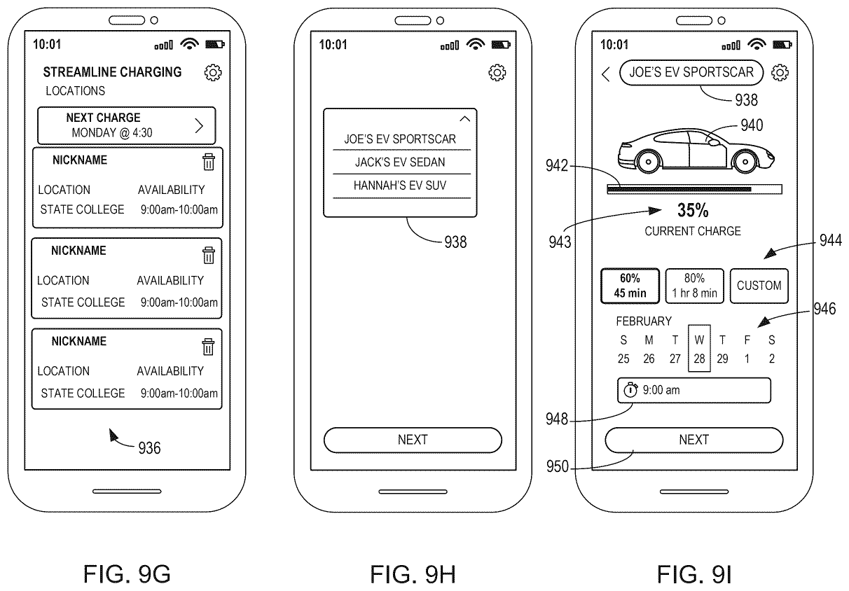

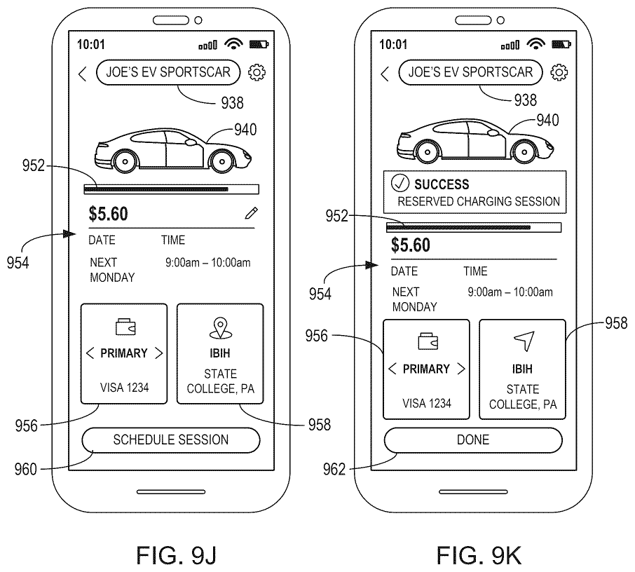

For the purpose of illustration, referring now to FIGS. 9A-9K, and with continued reference to FIG. 8B, FIGS. 9A-9K show screenshots of an example GUI for a user device for use with a system for multi-space vehicle charging, according to some non-limiting embodiments or aspects. As shown in FIGS. 9A-9K, user device 150 may display a GUI (e.g., based on a user opening a mobile application associated with cord management system 110 on user device 150, navigating a web browser of user device 150 to a website associated with cord management system 110, and/or the like). The GUI may include a plurality of graphical elements including images, text (e.g., messages, instructions, and/or the like), buttons, dropdown menus, text boxes, password boxes (e.g., a text box that conceals the characters typed therein), checkboxes, and/or the like.

As shown in FIG. 9A, the user may initially select button 902 to sign up/create an account or select button 904 to login to an existing account.

As shown in FIG. 9B, in response to selecting button 902 to sign up/create an account, the user may input a password into password boxes 906 and 908. The user may then select button 910 to advance to the next screen.

As shown in FIG. 9C, in response to the user selecting button 910, the user may enter information into text boxes 912-916 (e.g., first name, last name, email address, and/or the like). The user may then select button 918 to advance to the next screen.

Referring again to FIG. 8B, at step 854, method 800b may include receiving vehicle (e.g., EV) data. For example, user device 150 and/or remote system 160 may receive vehicle data associated with vehicle 402.

For the purpose of illustration, referring again to FIGS. 9A-9K and with continued reference to FIG. 8B, as shown in FIG. 9D, the user may input data about vehicle 402 by making selections from dropdown menus 920 and 922 (e.g., make and model of vehicle 402 and/or the like) and/or entering identifying information (e.g., the license plate number) in text box 924. Based on the vehicle information (e.g., make and model of vehicle), system 100 (e.g., user device 150 and/or remote system 160) may determine (e.g., retrieve, lookup, calculate, and/or the like) the battery capacity and/or charging characteristics (e.g., charging rate, voltage capacity, current capacity, and/or the like) of vehicle 402. For example, system 100 may look up the battery capacity and/or charging characteristics in at least one database. In some non-limiting embodiments or aspects, the battery capacity and/or charging characteristics may be used (e.g., by system 100) to predict charging time. Additionally, or alternatively, the user may indicate acceptance of terms of service by selecting checkbox 926. The user may then select button 928 to advance to the next screen.

As shown in FIG. 9E, in response to selecting button 928, the user may enter payment information into text boxes 930 (e.g., first name, last name, address, state, zip code, card number, expiration date, security code/card verification value (CVV), and/or the like). The user may then select button 932 to advance to the next screen.

Referring again to FIG. 8B, at step 856, method 800b may include receiving location data. For example, user device 150 and/or remote system 160 may receive location data associated with vehicle 402 and/or a selected location.

For the purpose of illustration, referring again to FIGS. 9A-9K and with continued reference to FIG. 8B, as shown in FIG. 9F, the user may select button 934 to input and/or select a location.

Referring again to shown in FIG. 8B, at step 858, method 800b may include receiving a request to charge a vehicle. For example, cord management system 110, charging device 102, and/or remote system 160 may receive a request to charge vehicle 402 (e.g., from user device 150), as described herein. In some non-limiting embodiments or aspects, step 858 of FIG. 8B may be the same as or similar to step 802 of FIG. 8A.

For the purpose of illustration, referring again to FIGS. 9A-9K and with continued reference to FIG. 8B, as shown in FIG. 9G, based on inputting or selecting locations, buttons 936 allow the user to select one of the added locations to schedule a charging session.

As shown in FIG. 9H, in response to selecting a location, the user may select one of the added vehicles from dropdown menu 938.

As shown in FIG. 9I, image 940 of the selected vehicle may be displayed, and text 943 may indicate a current charge level of vehicle 402. For example, remote system 160 and/or user device 150 may communicate with vehicle 402 (e.g., via an application programming interface (API) to obtain the current charge level. The user may select one of buttons 944 to select an amount of charging desired (e.g., 60% of capacity of vehicle 402, 80% of capacity of vehicle 402, a custom amount of the capacity of vehicle 402, and/or the like), and bar graphic 942 may indicate the amount of charged capacity associated with the selection of the one of buttons 944. The user may select one of date buttons 946 and may select a time from dropdown menu 948. The available dates and times in date buttons 946 and dropdown menu 948 may be based on predicted charging time for vehicle 402 to reach the selected amount of charging. For example, the battery capacity and/or charging characteristics of vehicle 402 may be used (e.g., by system 100) to predict charging time, as described herein. The user may then select button 950 to advance to the next screen.

Referring again to FIG. 8B, at step 860, method 800b may include scheduling a charging session. For example, cord management system 110, charging device 102, and/or remote system 160 may schedule a charging session based on receiving the request to charge vehicle 402.

For the purpose of illustration, referring again to FIGS. 9A-9K and with continued reference to FIG. 8B, as shown in FIG. 9J, bar graphic 952 may change shade and/or color (e.g., with respect to bar graphic 942), which may indicate that the current screen of the GUI is a confirmation screen (e.g., rather than the previous selection screen). Text 954 may indicate the selections from the previous screen. Additionally, or alternatively, the price information in text 954 may be determined (e.g., by system 100, user device 150, and/or remote system 160) based on the selected amount of charging and the cost of electricity. The user may select button 956 to select a payment method. The user may select 958 to change the location, if desired. The user may then select button 960 to schedule the charging session and advance to the next screen.

As shown in FIG. 9K, based on the charging session being scheduled, the selections associated with the charging session may be displayed (e.g., in dropdown menu 938, image 940, bar graphic 952, text 954, button 956, and button 958). The user may then select button 962 to exit the scheduling process.

Referring again to FIG. 8B, at step 862, method 800b may include moving a charging connector of a cord to a parking space of the vehicle during the charging session. For example, cord management system 110 may move charging connector 119 of cord 118 (e.g., by moving cart 116 and/or activating motor 128) to parking space 404 of vehicle 402 during the charging session, as described herein. In some non-limiting embodiments or aspects, step 862 of FIG. 8B may be the same as or similar to step 804 of FIG. 8A.

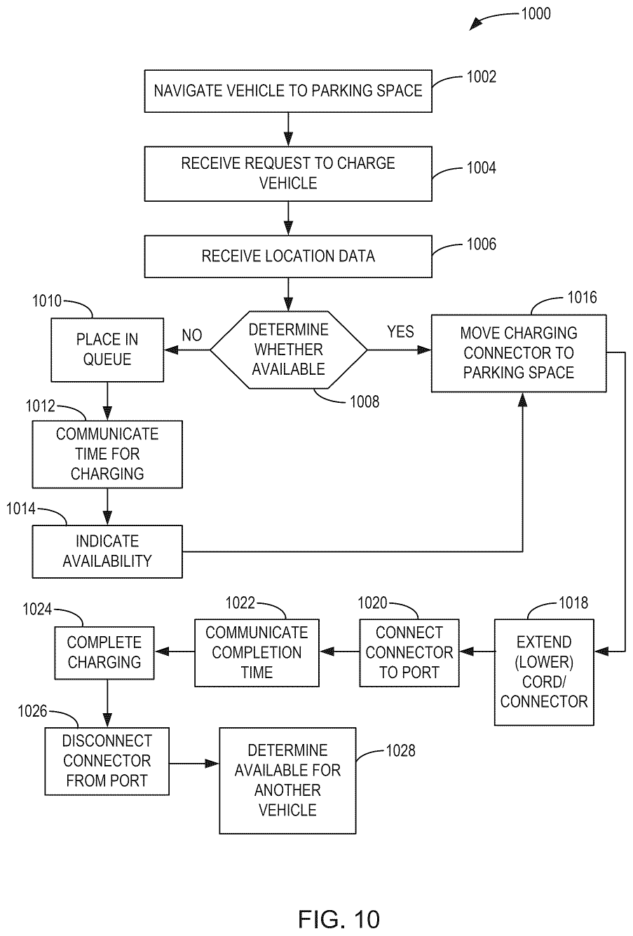

Referring now to FIG. 10, shown is a flow diagram of an example method 1000 for multi-space vehicle charging, according to some non-limiting embodiments or aspects. The steps shown in FIG. 10 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 1000 may be performed (e.g., completely, partially, and/or the like) by cord management system 110 (e.g., a processor or computing device thereof). In some non-limiting embodiments or aspects, one or more of the steps of method 1000 may be performed (e.g., completely, partially, and/or the like) by another system, another device, another group of systems, or another group of devices, separate from or including cord management system 110, such as charging device 102 (e.g., a processor or computing device thereof), user device 150, remote system 160, and/or the like.

As shown in FIG. 10, at step 1002, method 1000 may include a user navigating (e.g., driving) vehicle 402 into parking space 404 associated with cord management system 110. For example, a user may drive the vehicle into parking space 404 in a parking area associated with system 100 and/or cord management system 110.

As shown in FIG. 10, at step 1004, method 1000 may include receiving a request to charge a vehicle, as described herein. For example, the user may request charging on a mobile application on user device 150.

As shown in FIG. 10, at step 1006, method 1000 may include receiving location data, as described herein. For example, the user may input data associated with parking space 404 and/or the location thereof into the mobile application on user device 150.

As shown in FIG. 10, at step 1008, method 1000 may include determining whether system 100 (e.g., charging device 102 and/or cord management system 110) is in use, as described herein. For example, the mobile application on user device 150 may communicate with charging device 102, cord management system 110, and/or remote system 160 to check if system 100 (e.g., charging device 102 and/or cord management system 110 thereof) is available.

As shown in FIG. 10, at step 1010, method 1000 may include placing the user and/or vehicle 402 into a queue, as described herein. For example, the mobile application on user device 150, charging device 102, cord management system 110, and/or remote system 160 may place the user into an electronic queue if system 100 is not available/is in use, as described herein.

As shown in FIG. 10, at step 1012, method 1000 may include communicating a time for a charging session, as described herein. For example, charging device 102, cord management system 110, and/or remote system 160 may communicate and/or user device 150 may display a time when the user may plug in vehicle 402 (e.g., based on the queue, charging status of another vehicle connected to/charging from system 100, and/or the like).

As shown in FIG. 10, at step 1014, method 1000 may include communicating an indication that system 100 is available, as described herein. For example, charging device 102, cord management system 110, and/or remote system 160 may communicate and/or user device 150 may display a notification that system 100 is available.

As shown in FIG. 10, at step 1016, method 1000 may include moving a charging connector of a cord to a parking space of the vehicle during charging session, as described herein. For example, cord management system 110 may move cart 116 (e.g., along rail 122) to parking space 404 that the user had previously inputted into the mobile application of user device 150.

As shown in FIG. 10, at step 1018, method 1000 may include extending cord 118 and/or charging connector 119 thereof, as described herein. For example, cord management system 110 may extend and/or lower cord 118 and/or charging connector 119 from cart 116.

As shown in FIG. 10, at step 1020, method 1000 may include connecting (e.g., mating) charging connector 119 to charging port 406 of vehicle 402, as described herein. For example, a user may plug in charging connector 119 to charging port 406. Additionally, or alternatively, charging connector 119 may be automatically mated to charging port 406.

As shown in FIG. 10, at step 1022, method 1000 may include communicating a charging session completion time, as described herein. For example, charging station 102, cord management system 110, and/or remote system 160 may communicate and/or user device 150 may display a completion time for the charging session.

As shown in FIG. 10, at step 1024, method 1000 may include the charging session being completed, as described herein. For example, vehicle 402 may be charged to its full capacity. Additionally, or alternatively, vehicle 402 may be charged to a selected amount (e.g., a percentage of its capacity).

As shown in FIG. 10, at step 1026, method 1000 may include disconnecting charging connector 119 from charging port 406 of vehicle 402, as described herein. For example, the user (or another user, such as the owner of another vehicle or a parking lot attendant) may unplug charging connector 119 from charging port 406. Additionally, or alternatively, charging connector 119 may be automatically disconnected from charging port 406.

As shown in FIG. 10, at step 1028, method 1000 may include determining system 100 is available for another user/another vehicle 402, as described herein. For example, charging device 102, cord management system 110, remote system 160, and/or user device 150 may determine that system 100 (e.g., charging device 102 and/or cord management system 110 thereof) is available/no longer in use (and may mark/update a status associated with system 100 accordingly).

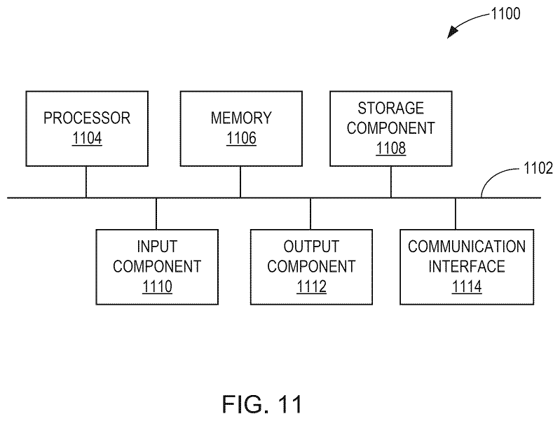

Referring now to FIG. 11, shown is a diagram of example components of a device 1100 according to non-limiting embodiments. Device 1100 may correspond to charging device 102, cord management system 110, user device 150, remote system 160, and/or power source 170, as an example. In some non-limiting embodiments, such systems or devices may include at least one device 1100 and/or at least one component of device 1100. The number and arrangement of components shown are provided as an example. In some non-limiting embodiments, device 1100 may include additional components, fewer components, different components, or differently arranged components than those shown. Additionally, or alternatively, a set of components (e.g., one or more components) of device 1100 may perform one or more functions described as being performed by another set of components of device 1100.

As shown in FIG. 11, device 1100 may include bus 1102, processor 1104, memory 1106, storage component 1108, input component 1110, output component 1112, and communication interface 1114. Bus 1102 may include a component that permits communication among the components of device 1100. In some non-limiting embodiments, processor 1104 may be implemented in hardware, firmware, or a combination of hardware and software. For example, processor 1104 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1106 may include random access memory (RAM), read only memory (ROM), and/or another type of dynamic or static storage device (e.g., flash memory, magnetic memory, optical memory, etc.) that stores information and/or instructions for use by processor 1104.

With continued reference to FIG. 11, storage component 1108 may store information and/or software related to the operation and use of device 1100. For example, storage component 1108 may include a hard disk (e.g., a magnetic disk, an optical disk, a magneto-optic disk, a solid-state disk, etc.) and/or another type of computer-readable medium. Input component 1110 may include a component that permits device 1100 to receive information, such as via user input (e.g., a touch screen display, a keyboard, a keypad, a mouse, a button, a switch, a microphone, etc.). Additionally, or alternatively, input component 1110 may include a sensor for sensing information (e.g., a global positioning system (GPS) component, an accelerometer, a gyroscope, an actuator, etc.). Output component 1112 may include a component that provides output information from device 1100 (e.g., a display, a speaker, one or more light-emitting diodes (LEDs), etc.). Communication interface 1114 may include a transceiver-like component (e.g., a transceiver, a separate receiver and transmitter, etc.) that enables device 1100 to communicate with other devices, such as via a wired connection, a wireless connection, or a combination of wired and wireless connections. Communication interface 1114 may permit device 1100 to receive information from another device and/or provide information to another device. For example, communication interface 1114 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1100 may perform one or more processes described herein. Device 1100 may perform these processes based on processor 1104 executing software instructions stored by a computer-readable medium, such as memory 1106 and/or storage component 1108. A computer-readable medium may include any non-transitory memory device. A memory device includes memory space located inside of a single physical storage device or memory space spread across multiple physical storage devices. Software instructions may be read into memory 1106 and/or storage component 1108 from another computer-readable medium or from another device via communication interface 1114. When executed, software instructions stored in memory 1106 and/or storage component 1108 may cause processor 1104 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system for multi-space vehicle charging, comprising:
a cord management system configured to extend across a plurality of parking spaces and configured to move a charging connector of a cord to at least one selected parking space of the plurality of parking spaces associated with at least one vehicle.

2. The system of claim 1, wherein the cord management system comprises:
an input connector configured to connect to a charging device charging connector of a charging device cord of a charging device;
a drag chain comprising at least one cable within the drag chain, the at least one cable configured to connect to the input connector; and
a cart connected to the drag chain and movably attached to at least one rail extending across the plurality of parking spaces, the cart comprising the cord, the cord configured to connect to the at least one cable within the drag chain.

3. The system of claim 2, wherein the cart comprises at least one cord feeding assembly configured to at least one of: extend the cord, retract the cord, or any combination thereof.

4. The system of claim 2, wherein the cord management system is configured to be mounted on a substantially vertical surface.

5. The system of claim 4, wherein the cord management system comprises at least one mounting bracket configured to mount the cord management system to the substantially vertical surface.

6. The system of claim 5, wherein the substantially vertical surface comprises at least one of: a wall, a support beam, or any combination thereof.

7. The system of claim 2, wherein the cord management system comprises at least one support configured to suspend the cord management system above at least one of: a ground, a floor, a substantially horizontal surface, an inclined surface, or any combination thereof.

8. The system of claim 2, further comprising:
at least one motor; and
at least one belt connected to the at least one motor and the cart,
wherein the at least one motor is configured to move the cart along the at least one rail by moving the at least one belt.

9. The system of claim 8, wherein the cart comprises at least one sliding element, wherein the at least one rail comprises at least one track, wherein the cart is movably attached to the at least one rail by the at least one sliding element being in contact with the at least one track, and wherein the at least one sliding element is configured to slide along the at least one rail as the cart moves along the at least one rail.

10. The system of claim 8, further comprising at least one processor configured to:
receive a request to charge a vehicle of the at least one vehicle; and
activate the at least one motor to move the charging connector of the cord to a parking space of the plurality of parking spaces associated with the vehicle.

11. The system of claim 2, further comprising at least one processor configured to:
receive a request to charge a vehicle of the at least one vehicle; and
move the charging connector of the cord to a parking space of the plurality of parking spaces associated with the vehicle.

12. The system of claim 1, wherein the cord management system comprises:
at least one cord feeding assembly configured to receive the cord; and
a cart movably attached to at least one rail and configured to move one or more of the at least one cord feeding assembly to move the cord.

13. The system of claim 12, wherein the cord management system is configured to be mounted on a vertical surface.

14. The system of claim 1, wherein the at least one vehicle comprises at least one of: an electric vehicle, a plug-in hybrid vehicle, or any combination thereof.

15. A method for multi-space vehicle charging, comprising:
receiving, with at least one processor, a request to charge a vehicle located in a parking space of a plurality of parking spaces; and
moving, with at least one processor, a charging connector of a cord to the parking space of the vehicle.

16. The method of claim 15, wherein the cord extends from a charging device, the method further comprising:
determining, with at least one processor, whether the charging device is in use.

17. The method of claim 16, wherein moving the charging connector of the cord comprises moving the charging connector of the cord to the parking space of the vehicle based on determining that the charging device is not in use.

18. The method of 16, further comprising:
adding, with at least one processor, the vehicle to a queue based on determining that the charging device is in use; and
communicating, with at least one processor, a notification when the charging device is no longer in use based on a position of the vehicle in the queue,
wherein moving the charging connector of the cord comprises moving the charging connector of the cord to the parking space of the vehicle based on determining that the charging device is no longer in use and based on the position of the vehicle in the queue.

19. The method of claim 15, wherein a cord management system comprises at least one cord feeding assembly configured to receive the cord and a cart movably attached to at least one rail and configured to move one or more of the at least one cord feeding assembly to move the cord, and wherein moving the charging connector of the cord comprises moving the cart.

20. The method of claim 15, further comprising:
creating, with at least one processor, an account for a user associated with the vehicle before receiving the request to charge the vehicle;
receiving, with at least one processor, vehicle data associated with at least one vehicle comprising the vehicle before receiving the request to charge the vehicle;
receiving, with at least one processor, location data before receiving the request to charge the vehicle; and
scheduling, with at least one processor, a charging session based on receiving the request to charge the vehicle,
wherein moving the charging connector comprises moving the charging connector of the cord to the parking space of the vehicle during the charging session.
